(19) United States
(12) Patent Application Publication
(10) Pub. No.: US 2013/0003216 A1
(43) Pub. Date: Jan. 3, 2013

(54) HEAD CONTROLLER, MEMORY DEVICE AND HEAD CONTROL METHOD

(75) Inventor: Masami YAMANE, Kawasaki-shi (JP)

(73) Assignee: Kabushiki Kaisha Toshiba, Tokyo (JP)

(21) Appl. No.: 13/398,513

(22) Filed: Feb. 16, 2012

(30) Foreign Application Priority Data
Jun. 30, 2011 (JP) 2011-146614

(51) Int. Cl. G11B 5/02

(52) U.S. Cl. 360/59; G9B/5.026

(57) ABSTRACT

In one embodiment, there is provided a head controller for controlling a head of a read/write device which reads/writes data from/into a recording medium. The head controller includes: a controller configured to adjust a gap between the head of the read/write device and a surface of the recording medium by increasing/decreasing a power supplied to a heater, wherein the heater is configured to heat and expand the read/write device; and an acquisition unit configured to acquire output differences of the read/write devices for two or more rotation speeds of the recording medium, wherein the controller is configured to increase or decrease the power supplied to the heater based on the output differences of the read/write device.

This application claims priority from Japanese Patent Application No. 2011-146614, filed on Jun. 30, 2011, the entire contents of which are hereby incorporated by reference.

### BACKGROUND

1. Field

Embodiments described herein relate to a head controller, memory device and head control method.

2. Description of the Related Art

In recent years, a technology known as dynamic flying height (hereinafter referred to as DFH) has become mainstream to achieve high-recording densities on hard disk drives (hereinafter referred to as HDD). DFH is a technology for controlling a flying height of a read/write device from a surface of a magnetic disk (in other words, the flying height indicates a gap between the read/write device and the surface of the magnetic disk). According to this technology, a heater and heat expander are provided near the read/write devices. Then, by energizing the heater, the heat expander becomes heated and therefore expands. This expansion causes the read/write device to move toward the magnetic disk.

Consideration has been given to predicting changes in flying height of a slider in the market from changes in the magnetic output before shipping and in the market. However, with this method, magnetic output changes due to heat fluctuations which generate measurement errors, thereby making it difficult to make complete predictions of the changes in the flying height. Furthermore, in order to solve the aforementioned problem, another method has been proposed that is unaffected by heat fluctuations. In this method, rewriting is performed in the market so that a difference between the magnetic output before shipping and the magnetic output in the market can be reduced. However, in this method, writing quality is inconsistent, which causes a large measurement error. Still further, in the market, touch down (also known as TD) detection has been considered. This causes concern regarding element abrasion so its implementation is difficult.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 is a sectional view of a magnetic disk device according to a present embodiment;

FIG. 2 is a diagram of the magnetic disk;

FIG. 3 is a block diagram showing the magnetic disk device according to the present embodiment;

FIG. 4 is a flowchart showing an example of the operation of the magnetic disk device according to the present embodiment;

FIG. 5 is an explanatory view showing heat fluctuations in the present embodiment;

FIG. 6 is a view showing floating changes caused by atmospheric pressure and rotation speeds in the present embodiment;

FIG. 7 is a view showing a relationship of the floating differences caused by atmospheric pressure and rotation speeds in the present embodiment;

FIG. 8 is a view showing an example of floating changes caused by humidity and rotation speeds in the present embodiment;

FIG. 9 is a view showing an example of the relationship of floating changes caused by humidity and rotation speeds in the present embodiment; and

FIG. 10 is a block diagram showing a configuration of the magnetic disk device according to the present embodiment.

### DETAILED DESCRIPTION

According to exemplary embodiments of the present invention, there is provided a head controller for controlling a head of a read/write device which reads/writes data from/into a recording medium. The head controller includes: a controller configured to adjust a gap between the head of the read/write device and a surface of the recording medium by increasing/decreasing a power supplied to a heater, wherein the heater is configured to heat and expand the read/write device; and an acquisition unit configured to acquire output differences of the read/write devices for two or more rotation speeds of the recording medium, wherein the controller is configured to increase or decrease the power supplied to the heater based on the output differences of the read/write device.

Exemplary embodiments of the present invention will be now described with reference to the drawings.

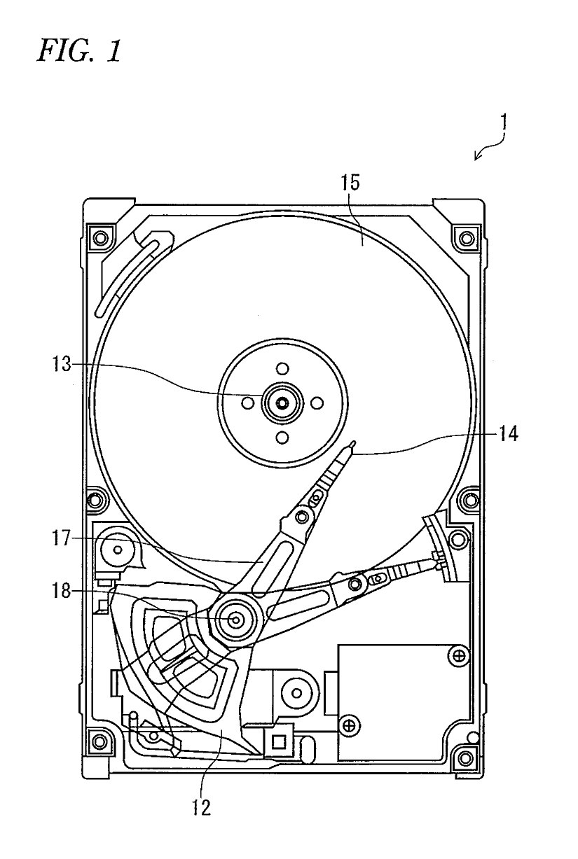

An overview of the magnetic disk device will be now described. FIG. 1 is a sectional view of a magnetic disk device according to a present embodiment. In the drawing, the magnetic disk 15 is a disk-shaped recording medium that records data. This disk is rotated by a spindle motor (hereinafter referred to as SMP) 13.

Read/write of the magnetic disk 15 is performed by a head 14 provided at one end of an arm 17 that is a head support mechanism. The head 14 performs read/write operation while floating slightly from a top surface of a magnetic disk 15 by lifting power generated by rotation of the magnetic disk 15. Also, the arm 17 turns around a circle centering on an axis 18, by drive from a voice-coil motor (hereinafter referred to as VCM) which is a head drive mechanism disposed on the other end of the arm 17. The head 14 moves to seek in a track traversing direction over the magnetic disk 15.

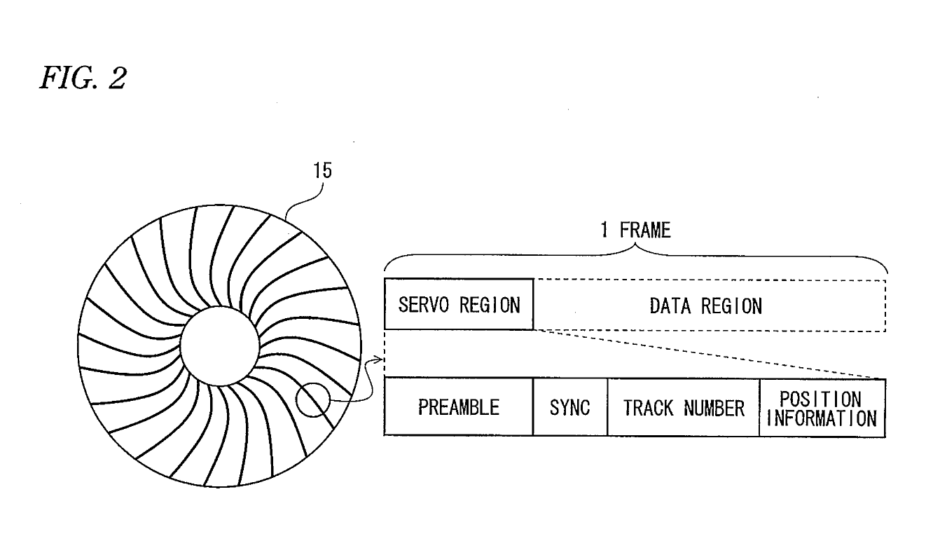

FIG. 2 is a schematic view of the magnetic disk. As shown in the drawing, a plurality of servo regions is provided radially on the magnetic disk 15.The servo region includes a preamble portion and a synchronizing portion, a track number that indicates a track position, and positioning information for accurately controlling a position of the radial direction of the head 14.

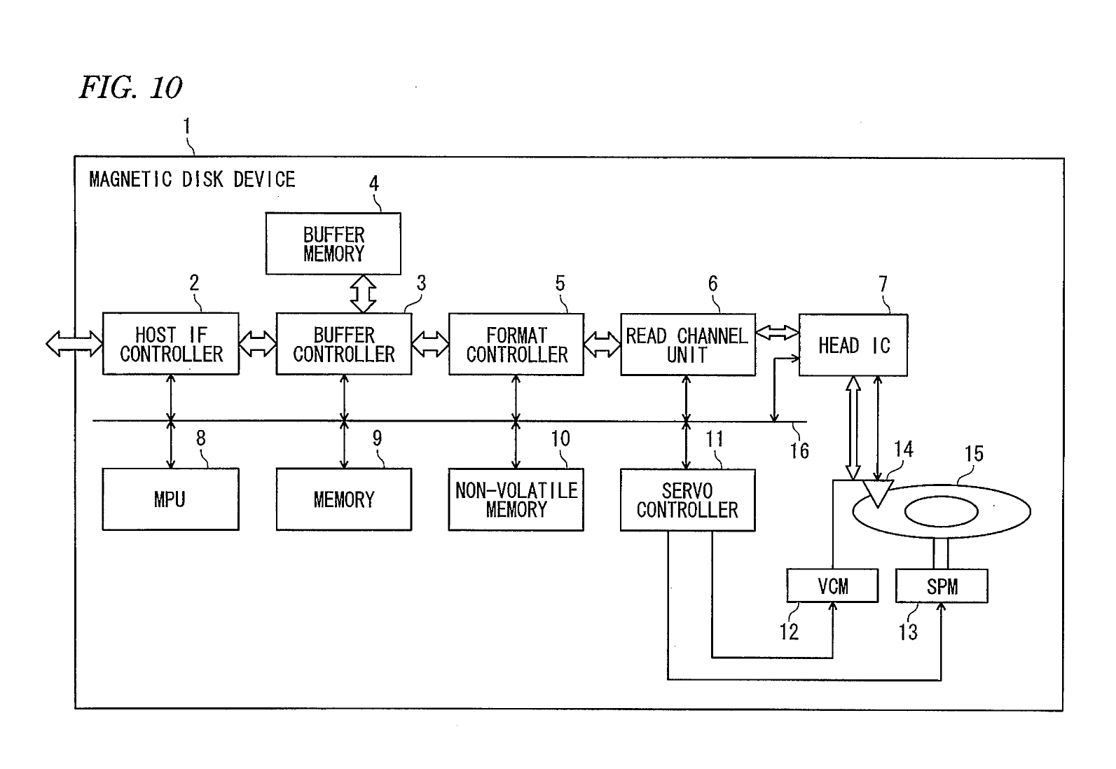

FIG. 10 is a block diagram showing a configuration of the magnetic disk device according to the present embodiment.

As shown in that drawing, the magnetic disk device 1 includes, for example, a host-interface controller (hereinafter referred to as a host IF controller) 2, a buffer-controller 3, a buffer memory 4, a format-controller 5, a read-channel unit 6, head IC 7, an MPU (Micro Processing Unit) 8, a memory 9, a non-volatile memory 10, a servo-controller 11, a VCM 12, an SPM 13, a head 14, a magnetic disk 15 and a shared bus 16.

The host IF controller 2 is connected to a host device of the magnetic disk device 1 and controls a communication with the host device. The buffer controller 3 controls the buffer memory 4. The buffer memory 4 temporarily stores data exchanged between the host device and the magnetic disk device 1.

The format controller 5 controls reading of data, and checks errors in read data, for example. The read-channel unit 6 amplifies the data signal output from the head IC 7 in data reading operation, and implements a predetermined process, such as AD conversion and demodulation. The head IC 7 includes a preamp (not shown) that pre-amplifies data signals read by the head 14 in data reading operation.

The MPU 8 implements a main control of the magnetic disk device 1 in accordance with a predetermined control program (firmware program). Specifically, the MPU8 controls each processing unit by decoding commands from the host device, and integrally controls read/write operation of data of the magnetic disk 15. Furthermore, in the embodiment, the MPU 8 implements calibration to adjust the distance between the magnetic head 22 and the magnetic disk 15.

The memory 9 and non-volatile memory 10 store firmware programs that operate on the MPU8, and respective control data. A servo controller 11 drives the VCM 12 and the SPM 13 while checking the operating status of the VCM 12 and the SPM 13.

The shared bus 16 connects each processing unit in the magnetic disk device 1 and exchange data between the processing units. The servo controller 11, the VCM 12, the SPM 13, the head 14 and the magnetic disk 15 have already been described, and thus any further descriptions thereof will be omitted herein.

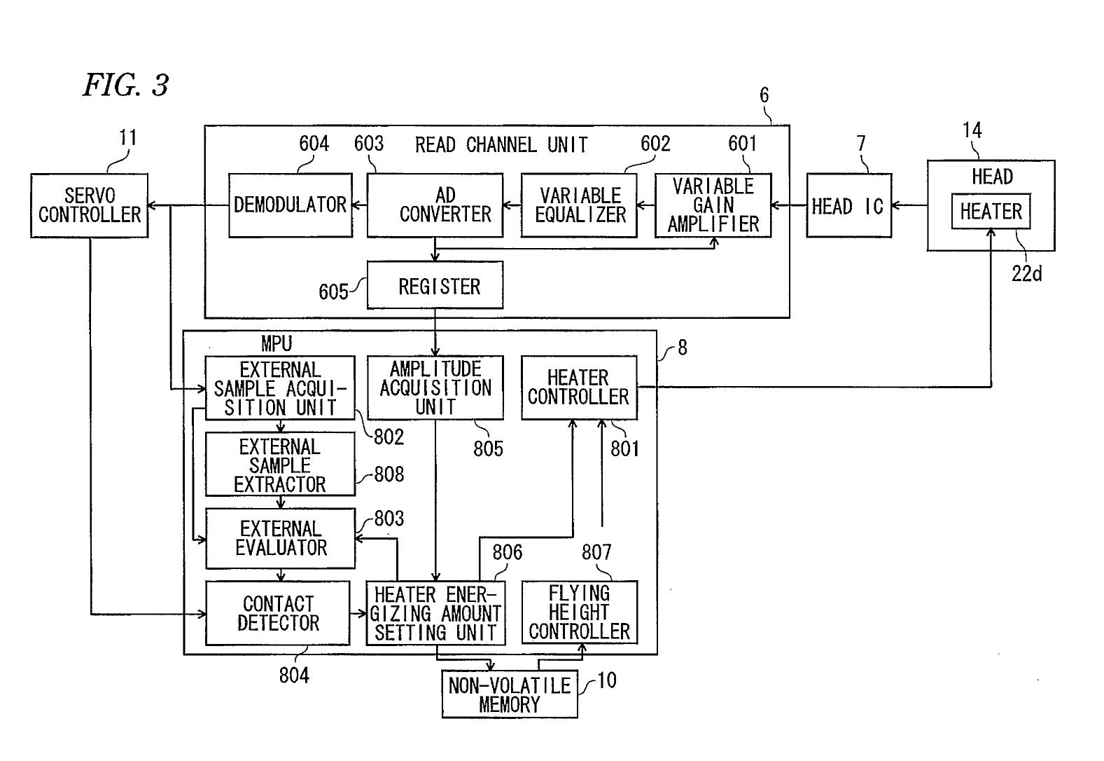

FIG. 3 is a block diagram showing the magnetic disk device according to the present embodiment. As shown in drawing, the read channel unit 6 includes a variable gain amplifier 601; a variable equalizer 602; and AD converter 603; a demodulator 604; and a register 605.

The variable gain amplifier 601 includes a variable gain that changes the gain. The variable gain amplifier 601 sets the gain according to gain signals fed back from the AD converter 603 to amplify data signals output from the head IC 7. At that time, the variable gain amplifier 601 sets the gain so that the level of the data signal after amplification is at a defined value. Specifically, an AGC (Auto Gain Control) loop is formed by the variable gain amplifier 601, the variable equalizer 602, and the AD converter 603.

The variable equalizer 602 adjusts frequency characteristics of the data signal amplified by the variable gain amplifier 601 and outputs the data signals to the AD converter 603.

The AD converter 603 performs AD conversion on the data signals output from the variable equalizer 602, and outputs the digital data signals to the demodulator 604. The AD converter 603 generates a gain signal to control gain of the variable gain amplifier 601 from a level of the data signal output from the variable equalizer 602, feeds back to the variable gain amplifier 601 and outputs to the register 605.

The demodulator 604 demodulates the digital data signals after AD conversion, and outputs the demodulated signals to the format-controller 5 that implements a data error check. Also, the demodulator 604 demodulates positioning information read from the servo region, and outputs the position information to the servo controller 11 as position error signals.

The register 605 temporarily holds the gain signals output from the AD converter 603 and then supplies the gain signals to the MPU8. The gain signals held by the register 605 indicate gains for amplifying the level of the data signals input to the variable gain amplifier 601 at a fixed value. If the level of the signal read by the head 14 is low, the gain increases. Meanwhile, if the level of the signal read by the head 14 is high, the gain decreases. Therefore, it is possible to obtain the regeneration amplitude of the data signal read by the head 14 from the gain signal held by the register 605.

Also, as shown in FIG. 3, the MPU8 includes a heater controller 801, an external sample acquisition unit 802, an external evaluator 803, a contact detector 804, an amplitude acquisition unit 805, a heater energizing amount setting unit 806, a flying height controller 807, and an external sample extractor 808, and the like.

The heater controller 801 controls the amount of power to energize (DFH power) a heater 22d built into the head 14. Specifically, the heater controller 801 sets the period to periodically decrease the DFH power according to instructions from the heater energizing amount setting unit 806 in calibration operation, and gradually increases the DFH power to move the magnetic head 22 toward the magnetic disk 15.

Also, in normal operation, the heater controller 801 adds to the heater 22d the DFH power indicated by the flying height controller 807.

The external sample acquisition unit 802 samples (obtains) position error signals output from the demodulator 604 to the servo controller 11 at predetermined sampling intervals. Also, this sampling interval is shorter than an interval specified by the heater energizing amount setting unit 806 to change the DFH power for the host IF controller 2 in the calibration operation. This is because it is necessary to sample fluctuations in the position error signal in response to change in the DFH power.

Furthermore, the external sample acquisition unit 802 may be configured to sample VCM current output from the servo controller 11 to the VCM 12 to correct a radial position of the magnetic head 22.

The external sample extractor 808 performs frequency analysis (FFT: Fast Fourier Transform) on the position error sampled by the external sample acquisition unit 802, and provides the position error signal to the band pass filter (BPF) to extract a predetermined frequency component (PES_FFT) from the sampled position error signal.

The external evaluator 803 temporarily stores the sampling values in the external sample acquisition unit 802 and calculates the representative value of the sampling values. The heater energizing amount setting unit 806 determines when the external evaluator 803 should sample the representative value to obtain the representative value at a given energizing amount. Also, it is difficult to determine the touch down from position error signals because the position error signals may have both positive and negative values. For this reason, it is advantageous to use the PES dispersion (a change in only a positive value) for the position error signals, rather than to use the position error signals themselves.

Also, when the predetermined frequency component is extracted by the external sample extractor 808, the external evaluator 803 temporarily stores the predetermined frequency component, and then calculates the representative value of the predetermined frequency component. In this embodiment, the external evaluator 803 calculates the sum of the predetermined frequency component as the representative value. The heater energizing amount setting unit 806 determines when the external evaluator 803 should calculate the representative value to obtain the representative value at a given DFH power.

The contact detector 804 determines the value that corresponds to the radial position of the magnetic head 22 obtained from the servo controller 11 as a threshold value, and compares that threshold value with the representative value calculated by the external evaluator 803, determines whether touch down has occurred, and outputs the results to the heater energizing amount setting unit 806.

Also, when the predetermined frequency component is extracted by the external sample extractor 808, the contact detector 804 determines, as a threshold value, a value corresponding to two times the average value of a representative value (the sum of the amplitudes of predetermined frequency components) calculated by the external evaluator 803 and a representative value (the sum of the amplitudes of predetermined frequency components) that is lower than the stage of the DFH power.

Also, the contact detector 804 compares the threshold value with the representative value calculated by the external evaluator 803 to determine whether touch down has occurred, and outputs the results to the heater energizing amount setting unit 806. According to the present embodiment, the contact detector 804 determines, as a threshold value, the value corresponding to two times the average value of the representative value of DFH power at 0-10 mW (in 1 mW increments). Also, the representative value in a stage lower than the stage of the DFH power is stored in a PC (personal computer) (not shown) that is equipped with the magnetic disk device 1.

The heater energizing amount setting unit 806 wholly controls execution of the calibration. The execution of calibration will be described in detail later. The heater energizing amount setting unit 806 calculates the DFH power required for setting the distance between the magnetic head 22 and magnetic disk 15 to a predetermined value based on the information obtained by calibration, and stores the calculated DFH power in the non-volatile memory 10.

The flying height of the slider is varied depending on the external environment (temperature, humidity, atmospheric pressure). Thus, before shipping, it is necessary to consider the decrease amount of the flying height caused by fluctuations in the external environment in the market. Also, it is necessary to reduce the flying height of the read/write device to increase the capacity of the magnetic disk device 1. Meanwhile, if it is possible to predict the external environment in the market, it is not necessary to ensure the decrease amount of the flying height before shipping, and it is possible to further increase the capacity of the magnetic disk device 1. It may be considered to predict the slider flying height using magnetic output so as to stabilize the flying height of the read/write devices, but the magnetic output is varied over time depending on changes in temperature, which causes flying height prediction errors.

Even if the magnetic output fluctuates due to thermal fluctuations, only the absolute value of the magnetic output fluctuates while the difference of the magnetic output does not fluctuate. In the present embodiment, this difference is employed.

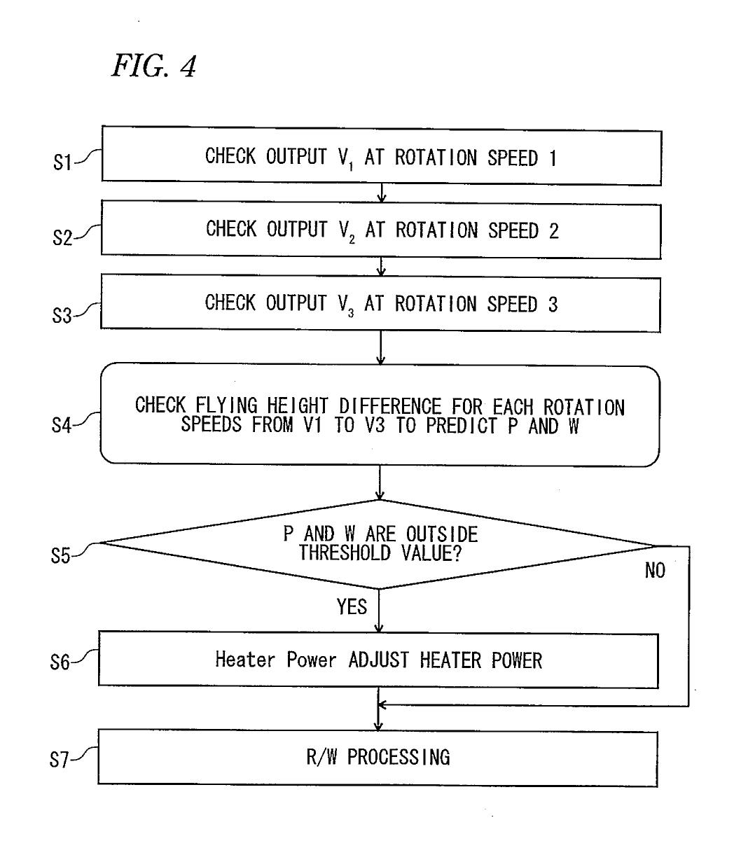

Also, in the slider, a rotation speed affects the flying height fluctuations. For example, the output P1-P3 (V1-V3) at different rotation speeds are checked as shown in FIG. 4 so as to calculate the flying height difference caused by the rotation speeds. Thus, it is possible to predict environmental fluctuations. By controlling the flying height of the read/write devices based on the heater power, it is possible to maintain the flying height of the read/write devices without being affected by changes in the environment.

For details, the amplitude acquisition unit 805 firstly checks the output V1 at rotation speed 1 (Step S1). Next, the amplitude acquisition unit checks the output V2 at rotation speed 2 (Step S2). Then, the amplitude acquisition unit checks the output V3 at rotation speed 3 (Step S3).

Then, the MPU8 checks the flying height difference for each rotation speed from V1 to V3, and predicts the outside external atmospheric pressure P and temperature W (Step S4). Then, it is determined whether P and W are outside of the threshold value (Step S5). If they are outside of the threshold value, the heater power is adjusted (Step S6). Then, the process goes to R/W processing regardless of whether they are outside of the threshold value (Step S7).

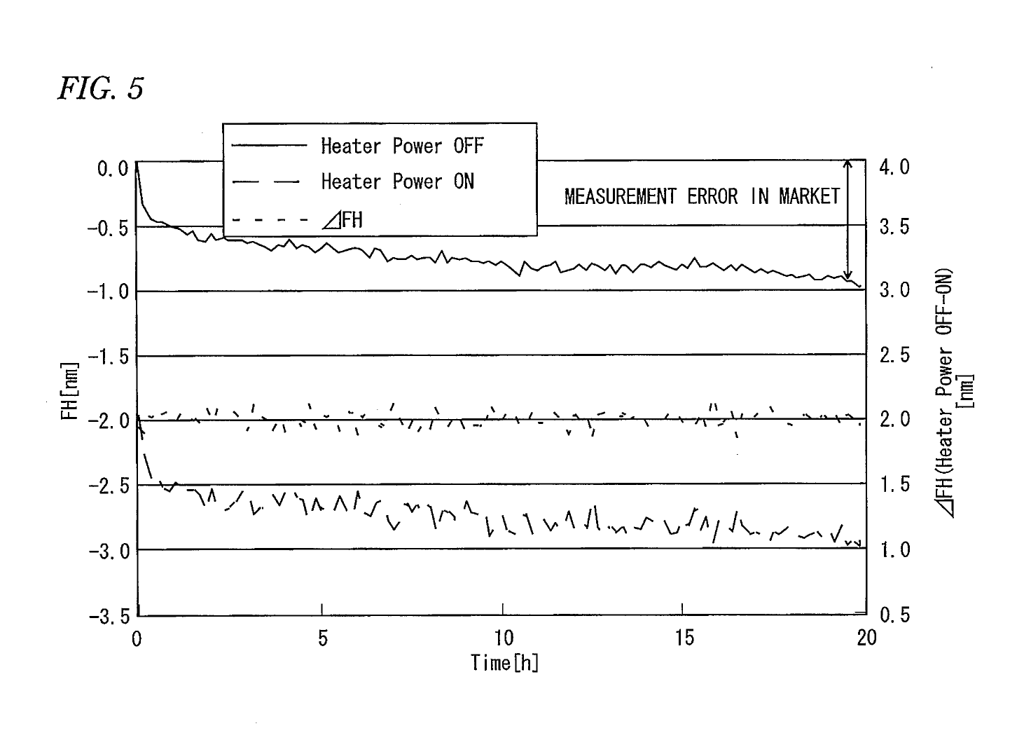

FIG. 5 shows a relationship between the prediction value of the flying height fluctuation and time. The solid line indicates when the heater power was turned off The broken lines are the predicted values of the fluctuation of flying height when the heater power is turned ON (when projected approximately 2 mm). These values fall over time, but output falls over time because of thermal fluctuations, and it only appears that flying height has fallen, but actually there is no change in the flying height. In other words, if the flying height fluctuation from output is simply predicted, measurement errors are caused.

In FIG. 5, the difference between the flying height when the heater power is on and the flying height when the heater power is off is indicated by a dotted line. In the drawing, the dotted line is substantially uniform; the difference between the flying height when the heater power is off and the flying height when the heater power is on is not affected by the thermal fluctuations. In the present embodiment, by using a difference measurement unaffected by thermal fluctuation, the external environment is predicted.

In the slider, a rotation speed affects the flying height fluctuations caused by the external environment. Especially, there are three types of external environmental factors, that is, temperature, humidity and atmospheric pressure. Also, since a temperature sensor is built into the magnetic disk device 1, it is not necessary to predict the temperature. Hereinafter, how to predict temperature and atmospheric pressure will be described.

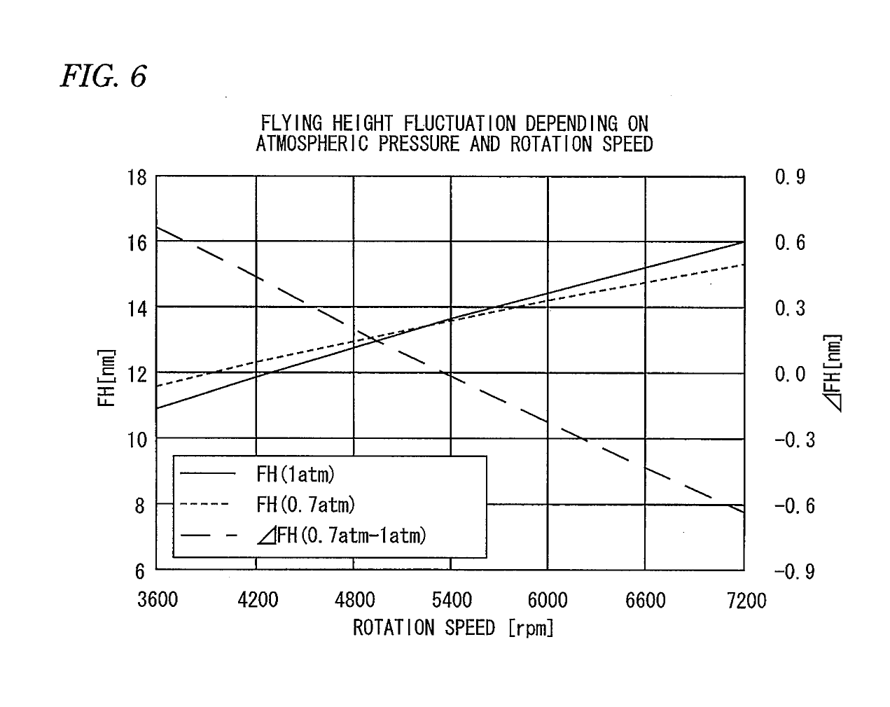

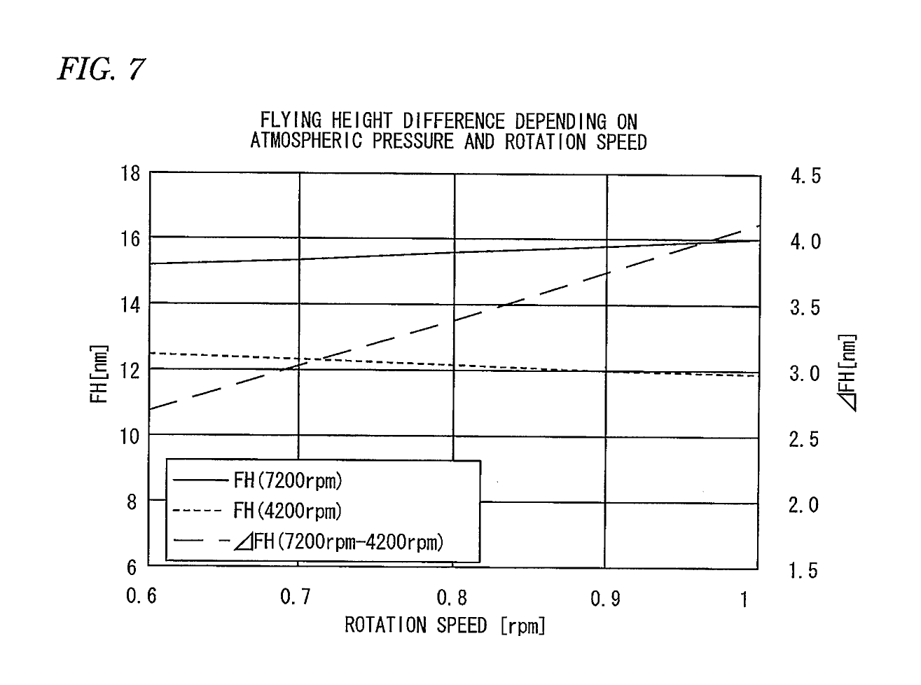

First of all, the atmospheric pressure will be described. FIG. 6 indicates the flying height fluctuation of the slider caused by atmospheric pressure and rotation speeds. The solid line, dotted line and broken line represent flying heights at 1 atm, flying heights at 0.7 atm and the differences therebetween. From the broken line, it can be found that a rotation speed affects the amount of change of the flying height of 1.0 atm and 0.7 atm. Therefore, by measuring the flying height at different rotation speeds, it is possible to predict changes in atmospheric pressure. The broken line in FIG. 7 shows the fluctuation of the floating amount at different rotation speeds. For example, in FIG. 7, the broken line represents the relationships between the flying height differences of 7,200 rpm, and 4,200 rpm and atmospheric pressure. As shown in FIG. 7, if the flying height difference of 7,200 rpm, and 4,200 rpm is 4.1 nm, it can be predicted that the atmospheric pressure is 1.0 atm. Also, if the flying height difference is 3.4 nm, it can be predicted that the atmospheric pressure is 0.8 atm.

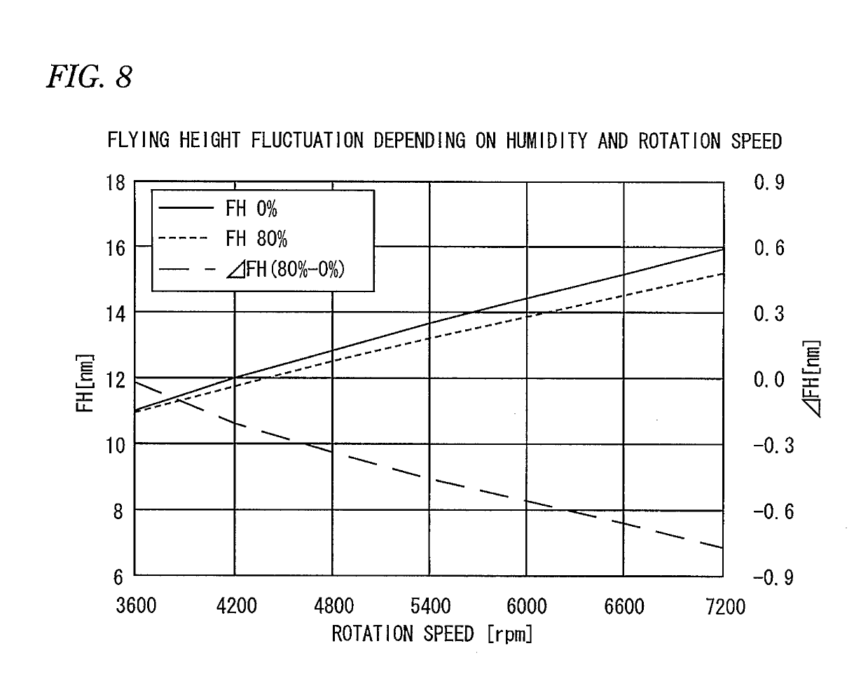

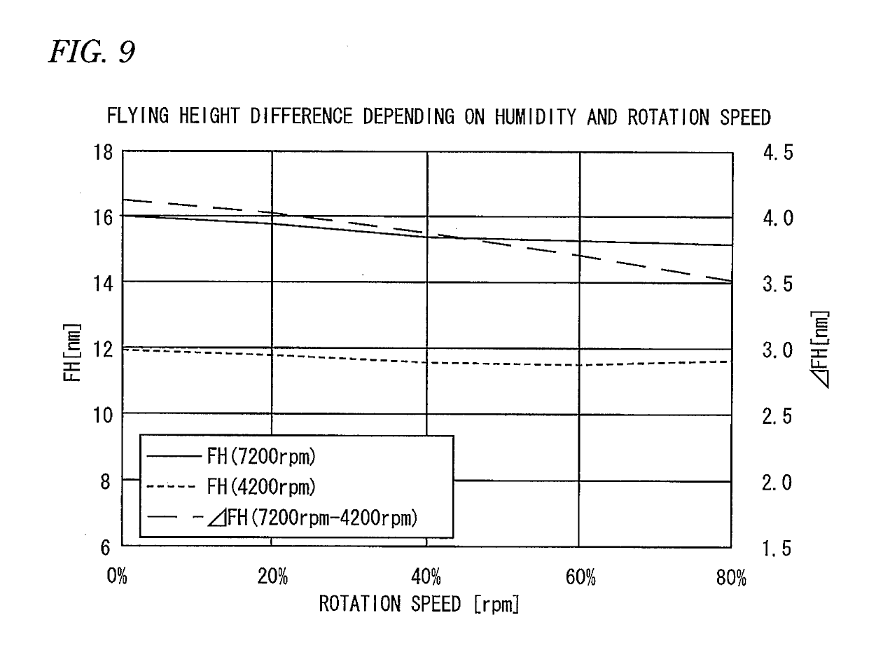

As described above, FIGS. 8 and 9 show the same relationships between the flying height differences and humidity. As shown in FIG. 9, if the flying height differences for different rotation speeds are known for each humidity, it is possible to predict each humidity. It is advantageous to have a table for the output differences of the atmospheric pressure and humidity for the rotation speeds to check output, such as the numerical values described in relation to FIG. 7.

While there are some variations for the flying height differences caused by the variations in tolerances of the slider, it is possible to accurately predict the humidity by calibrating the system before shipping.

In an actual market, both atmospheric pressure and humidity fluctuate are changed, and thus it is difficult to predict both humidity and atmospheric pressure using only rotating rotation speeds at two different points. When the flying height fluctuation for different rotation speeds is Δh, the atmospheric pressure is p, and the humidity is w, Δh is calculated based on the formula (1).

Δh=f(P)+g(W) (1)

In the formula (1), f( ) and g( ) represent certain functions. Because two parameters p and w are unknown, two or more flying height differences are required to calculate both p and w. Because it is possible to share one of different rotation speeds, it is possible to predict both atmospheric pressure and humidity. Of course, in order to improve precision, it is possible to measure three or more points to make a prediction.

Regarding the humidity, absolute humidity affects the slider. For this reason, absolute humidity can substantially be ignored at low temperatures. There is not need to consider absolute humidity at low temperatures. For this reason, it is possible to use temperature sensors built in the magnetic disk recorder to measure only flying heights of rotation speeds at two points, ignoring the humidity item g(w) when the disk is below a certain temperature, and use only f(p) to consider only the effect of atmospheric pressure. Furthermore, in the slider shown in FIGS. 6 to 9, an atmospheric pressure does not affect a flying height difference at 5,400 rpm. Therefore, for this kind of slider, it is possible to predict only the effect of humidity using only temperatures above a predetermined degree.

Since the flying height fluctuates according to the external environment, before shipping, it is necessary to consider the decrease amount of the flying height by fluctuations in the external environment in the market. Also, it is necessary to reduce the flying height of the read/write device to increase the capacity of the magnetic disk device 1. Meanwhile, if it is possible to predict the external environment in the market, it is not necessary to ensure a flying height for that amount when shipping, and it is possible to further increase the capacity.

In the market, it is considered to predict the slider flying height using magnetic output so as to uniform the flying height of the read/write devices. However, magnetic output will fluctuate over time because of changes in temperature, which causes flying height prediction errors.

In the present embodiment, it is not necessary to decrease a flying height to the extent that a gap is near 0 nm, and it is possible with an L/UL mechanism. Furthermore, it is possible to predict flying height fluctuations based on a table having environmental fluctuations, and to decrease the flying height of read/write devices. In this embodiment, it is possible to predict flying height fluctuations without being affected by heat fluctuations.

As the object and effect of the embodiment, in an HDD having the DFH feature, it is possible to predict flying height fluctuations of the slider according to environment fluctuations (atmospheric pressure and humidity fluctuations), and to control heater power and to maintain a gap between the head (elements) and the disk.

In the actual market, the atmospheric pressure and humidity both fluctuate, and that it is possible to predict both atmospheric pressure and humidity by measuring output differences at three or more rotation speeds.

In this embodiment, in order to predict the flying height according to the method described above, a table having the output differences between atmospheric pressure and humidity is required for the HDD, for example. In order to predict the external environment when the system is started up in the market of use, the system operates to take measurements of output at different rotation speeds.

Also, the magnetic disk recorder according to the present embodiment can be summarized as follows:

(1) A magnetic disk recorder that predicts the external environment from output differences at three or more rotation speeds only in high temperature regions (for example 50° C. or higher).

(2) A magnetic disk recorder that predicts atmospheric pressure and humidity based on three or more rotation speeds at high temperature regions (for example 50° C. or higher), predicts atmospheric pressure using only two or more rotation speeds at low-temperature regions (for example 50° C. or lower), and controls flying height.

With this configuration, it is possible to predict the external environment without an atmospheric pressure sensor or humidity sensor. Furthermore, it is unnecessary to consider issues such as the slider's dependency on its environment or rotation speeds, and thus it is possible to shorten slider development and to improve performance other than environment dependency.

Although the several embodiments of the invention have been described above, they are just examples and should not be construed as restricting the scope of the invention. Each of these novel embodiments may be practiced in other various forms, and part of it may be omitted, replaced by other elements, or changed in various manners without departing from the spirit and scope of the invention. These modifications are also included in the invention as claimed and its equivalents.

What is claimed is:

1. A head controller for controlling a head of a read/write device which reads/writes data from/into a recording medium, the head controller comprising:
a controller configured to adjust a gap between the head of the read/write device and a surface of the recording medium by increasing/decreasing a power supplied to a heater, wherein the heater is configured to heat and expand the read/write device; and
an acquisition unit configured to acquire output differences of the read/write devices for two or more rotation speeds of the recording medium,
wherein the controller is configured to increase or decrease the power supplied to the heater based on the output differences of the read/write device.

2. The head controller of claim 1, wherein
when temperature of the recording medium is more than a threshold value, the acquisition unit is configured to acquire the output differences of the read/write device for three or more rotation speeds of the recording medium.

3. The head controller according to claim 1, wherein the output differences are varied depending on atmospheric pressure or humidity.

4. The head controller according to claim 3, further comprising:
a table that stores the atmospheric pressure or the humidity.

5. A recorder comprising:
a recording medium;
a read/write device which reads/writes data from/into the recording medium and comprising a head;
a heater configured to heat and expand the read/write device;
a head controller configured to control the head of the read/write device, the head controller comprising:
a controller configured to adjust a gap between the head of the read/write device and a surface of the recording medium by increasing/decreasing a power supplied to the heater; and
an acquisition unit configured to acquire output differences of the read/write devices for two or more rotation speeds of the recording medium,
wherein the controller is configured to increase or decrease the power supplied to the heater based on the output differences of the read/write device.

6. A head control method for controlling a head of a read/write device which reads/writes data from/into a recording medium, the method comprising:
(a) adjusting a gap between the head of the read/write device and a surface of the recording medium by increasing/decreasing a power supplied to a heater, wherein the heater is configured to heat and expand the read/write device; and
(b) acquiring output differences of the read/write devices for two or more rotation speeds of the recording medium,
wherein step (a) comprises: increasing or decreasing the power supplied to the heater based on the output differences of the read/write device.
